(19) United States
(12) Patent Application Publication
(10) Pub. No.: US 2020/0233610 A1
(43) Pub. Date: Jul. 23, 2020

(54) DATA STORAGE DEVICE AND METHOD FOR ACCESSING LOGICAL-TO-PHYSICAL MAPPING TABLE THEREOF

(71) Applicant: Silicon Motion, Inc., Jhubei City (TW)

(72) Inventors: Jian-Wei SUN, Taipei City (TW); Sheng-Hsun LIN, Magong City (TW); Jui-Lin YEN, Taipei City (TW); Chien-Hsin KO, Taipei City (TW)

(21) Appl. No.: 16/585,608

(22) Filed: Sep. 27, 2019

(30) Foreign Application Priority Data
Jan. 21, 2019 (TW) 108102295

(51) Int. Cl. G06F 3/06; G06F 12/02; G06F 12/126

(52) U.S. Cl. CPC G06F 3/0659; G06F 12/0246; G06F 12/126; G06F 2212/1016; G06F 3/068; G06F 2212/1041; G06F 3/0604

(57) ABSTRACT

A data storage device is provided. The data storage device includes a flash memory, a dynamic random access memory (DRAM), and a controller. The flash memory stores a logical-to-physical mapping (L2P) table which is divided into a plurality of group-mapping tables. The DRAM stores a first set of the group-mapping tables. The controller loads a second set of the group mapping tables from the flash memory to the DRAM to replace the first set of the group-mapping tables using a predetermined replacement mechanism, and each group-mapping table of the second set has a corresponding column in an access information table that includes a flag and an access count. In response to the corresponding column of a specific group-mapping table in the second set not being zero, the controller excludes the specific group-mapping table from the predetermined replacement mechanism.

### CROSS REFERENCE TO RELATED APPLICATIONS

This Application claims priority of Taiwan Patent Application No. 108102295, filed on Jan. 21, 2019, the entirety of which is incorporated by reference herein.

### BACKGROUND OF THE INVENTION

### Field of the Invention

The present invention relates to data storage devices and, in particular, to a data storage device and a method for accessing a logical-to-physical mapping table thereof.

### Description of the Related Art

Flash memory devices typically include NOR flash devices and NAND flash devices. NOR flash devices are random access—a host accessing a NOR flash device can provide the device any address on its address pins and immediately retrieve data stored in that address on the device's data pins. NAND flash devices, on the other hand, are not random access but serial access. It is not possible for NAND flash devices to access any random address in the same way as the NOR flash devices. Instead, the host has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. In reality, the NAND flash device always reads complete pages from the memory cells and writes complete pages to the memory cells. After a page of data is read from the array into a buffer inside the device, the host can access the data bytes or words one by one by serially clocking them out using a strobe signal.

However, as the capacity of the NAND flash memory increases, if the dynamic random access memory (DRAM) on the controller side completely records the entire logical-to-physical mapping table of the NAND flash memory, the capacity requirement of the DRAM is also quite large, resulting in higher costs. If a DRAM having a smaller capacity is used, it is necessary to dynamically replace the group-mapping table in the DRAM. The conventional replacement mechanism may replace the newly read group-mapping table with the group-mapping table that has not been written into the flash memory. In addition to causing the mapping relationship error, the controller also needs to read the corresponding group-mapping table from the flash memory again, resulting in loss of performance.

Accordingly, there is a demand for a data storage device and a method for accessing the logical-to-physical mapping table thereof to solve the aforementioned problem.

### BRIEF SUMMARY OF THE INVENTION

In an exemplary embodiment, a data storage device is provided. The data storage device includes a flash memory, a dynamic random access memory (DRAM), and a memory controller. The flash memory includes a plurality of blocks for storing data and a logical-to-physical (L2P) table, wherein the L2P table is divided into a plurality of group-mapping tables. The DRAM is configured to store a first set of the group-mapping tables. The memory controller is configured to receive an access command from a host, wherein the access command comprises one or more logical addresses. The memory controller is further configured to read a second set of the group-mapping tables corresponding to the one or more logical addresses in the access command from the flash memory to replace at least one group-mapping table in the first set of group-mapping tables according to a predetermined replacement mechanism. Each group-mapping table in the second set of the group-mapping tables has a corresponding column in an access-information table, and the corresponding column comprises a flag and an access count. In response to the flag or the access count not being zero in the corresponding column of the access-information table corresponding to a specific group-mapping table in the second set of the group-mapping tables, the memory controller excludes the specific group-mapping table from the predetermined replacement mechanism.

In another exemplary embodiment, a method for accessing a logical-to-physical mapping (L2P) table in a data storage device is provided. The data storage device comprises a flash memory and a dynamic random access memory (DRAM). The flash memory comprises a plurality of blocks for storing data and the L2P table, wherein the L2P table is divided into a plurality of group-mapping tables, and the DRAM stores a first set of the group-mapping tables. The method includes the steps of: receiving an access command from a host, wherein the access command comprises one or more logical addresses; reading a second set of the group-mapping tables corresponding to the one or more logical addresses in the access command from the flash memory to replace at least one group-mapping table in the first set of the group-mapping tables according to a predetermined replacement mechanism, wherein each group-mapping table in the second set of group-mapping tables has a corresponding column in an access-information table, and the corresponding column comprises a flag and an access count; and in response to the flag or the access count not being zero in the corresponding column of the access-information table corresponding to a specific group-mapping table in the second set of the group-mapping tables, excluding the specific group-mapping table from the predetermined replacement mechanism.

### BRIEF DESCRIPTION OF THE DRAWINGS

The present invention can be more fully understood by reading the subsequent detailed description and examples with references made to the accompanying drawings, wherein:

FIG. 1 is a block diagram of an electronic device in accordance with an embodiment of the invention;

FIG. 2 is a schematic diagram illustrating interfaces to storage units of a flash storage in accordance with an embodiment of the invention;

FIG. 3 is a schematic diagram depicting connections between one access sub-interface and multiple storage sub-units according to an embodiment of the invention;

FIG. 4 is a diagram of the access information table and the logical-to-physical mapping table in accordance with an embodiment of the invention; and

FIGS. 5A-5B are sets of a flow chart of a method for accessing the logical-to-physical mapping table in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

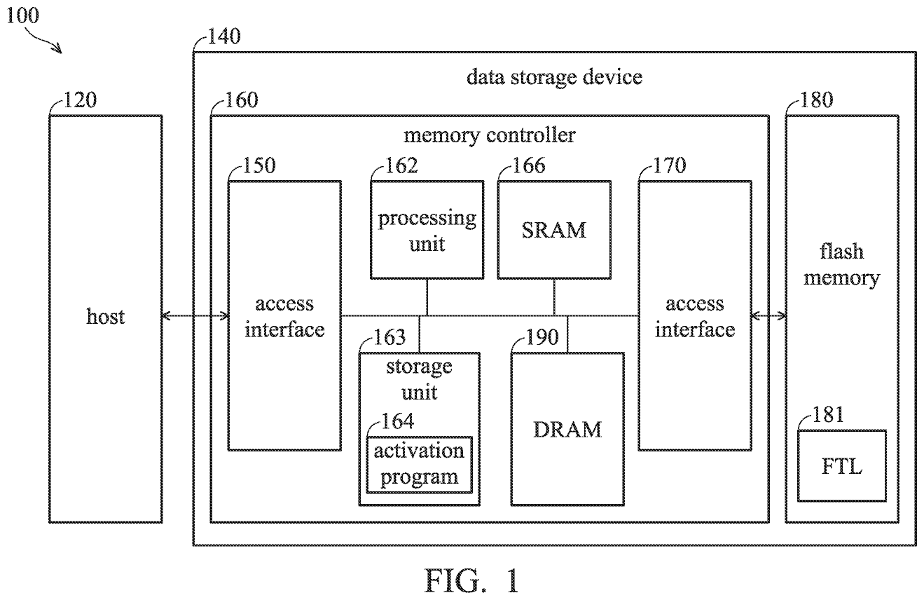

FIG. 1 is a block diagram of an electronic device in accordance with an embodiment of the invention. The electronic device 100 may be a personal computer, a data server, a network-attached storage (NAS), a portable electronic device, etc., but the invention is not limited thereto. The portable electronic device may be a laptop, a hand-held cellular phone, a smartphone, a tablet PC, a personal digital assistant (PDA), a digital camera, a digital video camera, a portable multimedia player, a personal navigation device, a handheld game console, or an e-book, but the invention is not limited thereto.

The electronic device 100 includes a host 120 and a data storage device 140. The data storage device 140 includes a memory controller 160, a flash memory 180 and a dynamic random access memory (DRAM) 190. The controller 160 includes a processing unit 162, a storage unit 163, a static random-access memory (SRAM) 166. The processing unit 162 can be implemented in various manners, such as dedicated hardware circuits or general-purpose hardware (for example, a single processor, a multi-processor capable of performing parallel processing, or other processor with computation capability). For example, the processing unit 162 may be implemented by a general-purpose processor or a microcontroller, but the invention is not limited thereto. In some embodiments, the DRAM 190 can be substituted by a host memory buffer (not shown) in the host 120. The storage space of the DRAM 190 is larger than that of the SRAM 166.

The processing unit 162 in the controller 160 may control the flash memory 180 according to the command from the host 120, such as writing data to a designated address of the flash memory 180 or reading page data from a designated address from the flash memory 180.

In the electronic device 100, several electrical signals for coordinating commands and data transfer between the processing unit 162 and the flash memory 180, including data lines, a clock signal and control lines. The data lines are employed to transfer commands, addresses and data to be written and read. The control lines are utilized to issue control signals, such as CE (Chip Enable), ALE (Address Latch Enable), CLE (Command Latch Enable), WE (Write Enable), etc.

The access interface 170 may communicate with the flash memory 180 using a SDR (Single Data Rate) protocol or a DDR (Double Data Rate) protocol, such as ONFI (open NAND flash interface), DDR toggle, or others. The processing unit 162 may communicate with the host 120 through an access interface 150 using a designated communication protocol, such as USB (Universal Serial Bus), ATA (Advanced Technology Attachment), SATA (Serial ATA), PCI-E (Peripheral Component Interconnect Express), NVME (Non-volatile Memory Express), or others.

The storage unit 163 may be a non-volatile memory such as a read-only memory (ROM), an erasable programmable read-only memory (EPROM), an electrically erasable programmable read-only memory (EEPROM), or an e-fuse, but the invention is not limited thereto. The storage unit 163 may store an activation program 164. The activation program may include boot code or a boot loader that is executed by the processing unit 162, and the controller 160 may be booted up based on the activation program 164 to control operations of the flash memory 180, such as reading in-system programming code.

The flash memory 180, for example, may be a NAND flash memory and the flash memory may include a plurality of storage sub-units, and each storage sub-unit can be implemented on a flash memory die that communicates with the processing unit 162 using the corresponding access sub-interface.

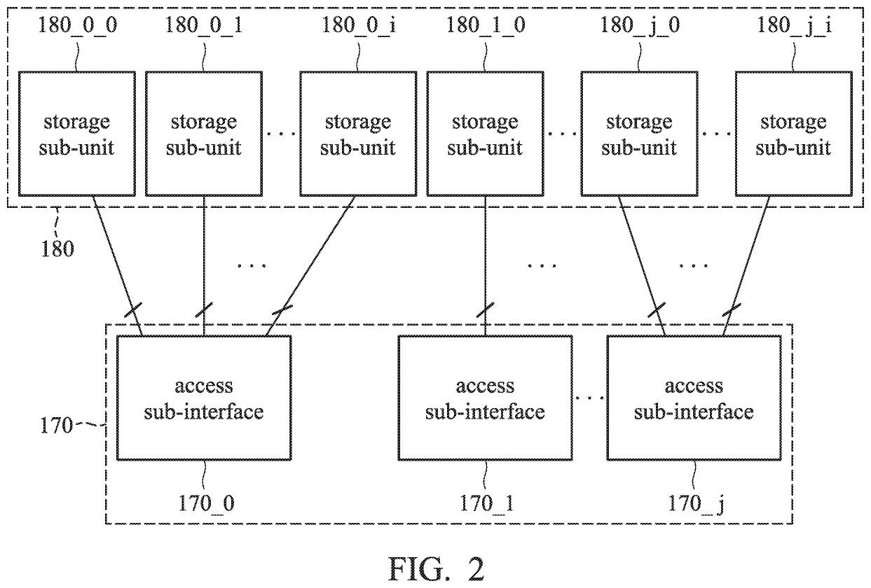

FIG. 2 is a schematic diagram illustrating interfaces to storage units of a flash storage in accordance with an embodiment of the invention.

The data storage device 140 may contain j+1 access sub-interfaces 170_0 to 170_j, where the access sub-interfaces may be referred to as channels, and each access sub-interface connects to i+1 storage sub-units. That is, i+1 storage sub-units may share the same access sub-interface. For example, assume that the flash memory contains 4 channels (j=3) and each channel connects to 4 storage sub-units (i=3): The flash memory 10 has 16 storage sub-units 180_0_0 to 180_j_i in total. The processing unit 110 may direct one of the access sub-interfaces 170_0 to 170_j to read data from the designated storage sub-unit. Each storage sub-unit has an independent CE control signal.

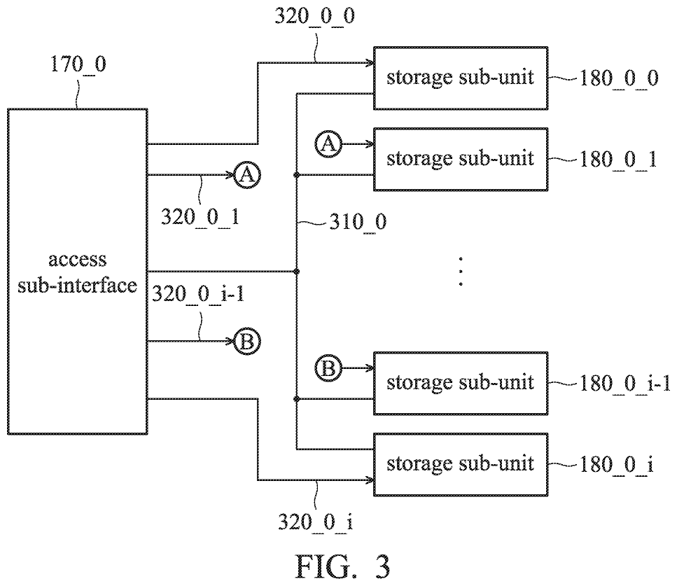

That is, it is required to enable a corresponding CE control signal when attempting to perform data read from a designated storage sub-unit via an associated access sub-interface. FIG. 3 is a schematic diagram depicting connections between one access sub-interface and multiple storage sub-units according to an embodiment of the invention. The processing unit 162, through the access sub-interface 170_0, may use independent CE control signals 320_0_0 to 320_0_i to select one of the connected storage sub-units 180_0_0 and 180_0_i, and then read data from the designated location of the selected storage sub-unit via the shared data line 310_0.

In an embodiment, while the data storage device 140 is operating, the memory controller 160 may built and update the logical-to-physical mapping (L2P) table, and the L2P table may be stored in the flash memory 180 of the data storage device 140, and may record the mapping information from the logical addresses to physical addresses. In addition, since the capacity of the DRAM 190 is limited or the data storage device 140 is not equipped with the DRAM 190 and uses the host memory buffer (HMB) instead, the entire L2P table cannot be completely loaded into the DRAM 190 or the HMB. In this situation, the memory controller 160 may load a set of L2P table into the DRAM 190 or the HMB.

In some embodiments, the basic unit of the L2P table may be implemented by a “superpage”. For example, the index in each logical terminal (e.g., can be regarded as global host page, GHP) is mapped into a superpage in the flash memory 180, and the superpage may include a plurality of physical pages. In some other embodiments, the basic unit of the L2P table may be implemented by a page or a sector, wherein the logical address, for example, may be a logical block address (LBA).

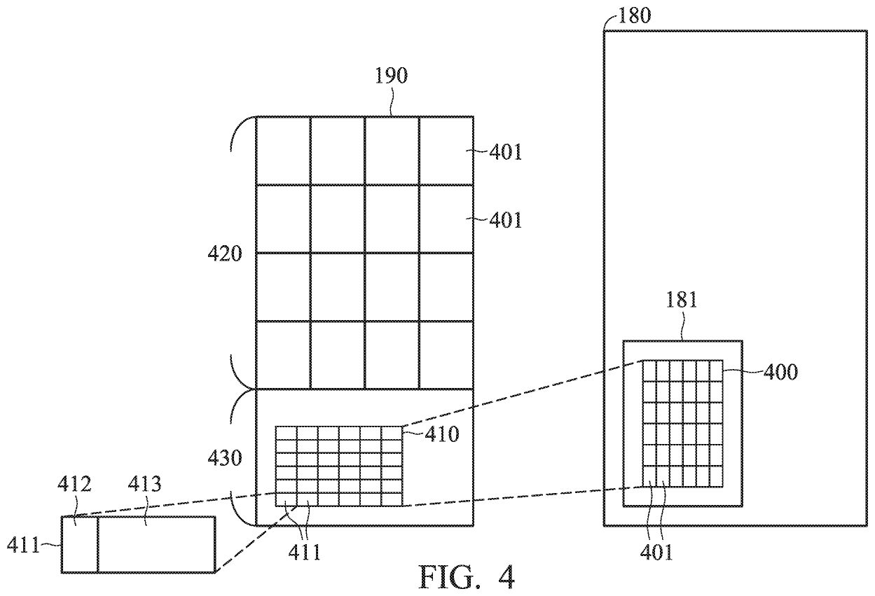

FIG. 4 is a diagram of the access information table and the logical-to-physical mapping table in accordance with an embodiment of the invention.

In an embodiment, the L2P table 400, for example, can be evenly divided into a plurality of group-mapping tables 401, such as 1024 group-mapping tables 401. The size of each group-mapping table 401 may be 4K bytes. Given that the size of each entry in each group-mapping table 401 is 4 bytes, each group-mapping table 401 may record 1024 pieces of mapping information. It should be noted that the size of each group-mapping table 401 can be set according to the requirement of practical designs, and the invention is not limited thereto. The memory controller 160, for example, may store a set of the group-mapping table 401 in the L2P table 400 to the first predetermined space 420 in the DRAM 190, such as 16 group-mapping tables 401, as depicted in FIG. 4.

The DRAM 190 may include an access-information table 410, and each group-mapping table 401 has a corresponding column 411 (e.g., 16 bits or 2 bytes) in the access-information table 410, each column 411 may record an access count 413 and a flag 412 for the corresponding group-mapping table 401. In an embodiment, the memory controller 160 may stores the access-information table 410 in the second predetermined space 430 in the DRAM 190. In another embodiment, the memory controller 160 may store the access-information table 410 in the SRAM 166, but the invention is not limited thereto.

For example, the most significant bit (MSB) in each column 411 may denote the flag 412 that represents whether data has been written into the corresponding group-mapping table 401 by a write command from the host 120. In addition, the second most significant bit to the least significant bit (LSB) in each column 411 may represent the access count 413 of the corresponding group-mapping table 401.

When the electronic device 100 is booting up, the memory controller 160 may reset all columns 411 in the access-information table, such as resetting values of all columns 411 to 0x0000. Then, the memory controller 160 may receive an access command from the host 120 to access the data stored in the flash memory 180, wherein the access command, for example, may be a write command, a read command, a trim command, etc. For example, the access command may include one or more logical addresses depending on the type of the write or read operation (e.g., sequential write/read, or sequential write/read). The logical addresses may be logical block addresses or global host pages. In addition, in order to optimize the flash memory 180, the storage space of the flash memory 180 is dynamically arranged to correspond to the logical address recognized by the host 120.

In an embodiment, assuming that the access command received by the memory controller 160 from the host 120 is a read command, the memory controller 160 may first determine whether the group-mapping table 401 corresponding to each logical address in the access command has been stored in the DRAM 190. If the group-mapping tables corresponding to some or all of the logical addresses have not been stored in the DRAM 190, the memory controller 160 may read the corresponding mapping tables 401 from the flash memory 180 to the DRAM 190, such as using a predetermined replacement mechanism to replace the newly read one or more group-mapping tables 401 to replace one or more group-mapping tables 401 originally stored in the DRAM 190. For example, the aforementioned predetermined replacement mechanism may be implemented by a least recently used (LRU) algorithm, a least frequently used (LFU) algorithm, a first-in-first-out (FIFO) algorithm, a second chance algorithm, etc., but the invention is not limited thereto.

If the group-mapping table 401 corresponding to each logical address in the access command has been stored in the DRAM 190, the memory controller 160 may increase the access count 413 by 1 in the column 411 of the access-information table 410 corresponding to the group-mapping table 401 for each logical address in the access command.

It should be noted that when the access count 413 in the column 411 is not zero, it indicates that the memory controller 160 may have to perform operations using the group-mapping table 401 corresponding to the column 411. Accordingly, the memory controller 160 may exclude the group-mapping table 401 corresponding to the column 411 from the predetermined replacement mechanism until the access count 413 in the column 411 is equal to 0.

In a first scenario, a specific group-mapping table 401 in the DRAM 190 may corresponding to a logical address in the access command, and the initial value of the column 411 in the access-information table 410 corresponding to the specific group-mapping table 401 is 0x0000. Since the memory controller 160 has to use the specific group-mapping table 401 to perform the access command, the memory controller 160 may change (or increase) the value of the column 411 in the access-information table 410 corresponding to the specific group-mapping table 401 to 0x0001.

In response to the memory controller 160 completing the access command, the memory controller 160 may change (or decrease) the value of the column 411 in the access-information table 410 corresponding to the specific group-mapping table 401 to 0x0000.

If the access command is a write command, the memory controller 160 may set the flag 412 to 1 in the column 411 of the access-information table 410 corresponding to the group-mapping table 401 for each logical address in the access command in response to completion of the access command. Meanwhile, the value of the column 411, for example, is changed to 0x8000. If the access command is a read command, the memory controller 160 may not change the value of the flag 412 in the column 411 (i.e., flag 412 kept at 0). For example, the value of the column 411 is 0x0000.

In a second scenario, a specific group-mapping table 401 in the DRAM 190 may correspond to a plurality of logical addresses (e.g., N logical addresses) in the access command (e.g., may be a write command or a read command), and the initial value of the column 411 in the access-information table 410 corresponding to the specific group-mapping table 401 is 0x0000. The memory controller 160 may increase the access count 413 by N in the column 411 before performing the access command. For example, if the initial value of the column 411 is 0x0000, and 3 logical addresses (e.g., logical address #100, #102, and #105) in the same access command correspond to the specific group-mapping table 401, the memory controller 160 may change (or increase) the value of the column 411 to 0x0003 in the access-information table 410 corresponding to the specific group-mapping table 401.

When the memory controller 160 is performing operations of the access command, if different logical addresses in the same access command correspond to the specific group-mapping table 401, the memory controller 160 may decrease the access count 413 by 1 in the column 411 of the access-information table 410 corresponding to the specific group-mapping table 401 each time after using (e.g., looking up) the specific group-mapping table 401. Since 3 logical addresses in the access command correspond to the specific group-mapping table 401 in the embodiment, the specific group-mapping table 401 will be used for at most 3 times while the memory controller is performing operations of the access command. When the memory controller 160 has completed the operations of the access command, the specific group-mapping table 401 is used for 3 times, and the access count 413 in the column 411 of the access-information table 410 will be decreased from 3 to 0.

In the second scenario, if the access command is a write command, the memory controller 160 may further set the flag 412 to 1 in the column 411 of the access-information table 410 corresponding to the specific group-mapping table 401 in response to completion of the access command. That is, the value of the column 411 is changed to 0x8000 in this time. If the access command is a read command, the memory controller 160 will not change the value of the flag 412 in the column 411 (e.g., flag 412 kept at 0). That is, the value of the column 411 is 0x0000.

It should be noted that, when the host 120 issues an access command to the memory controller 160, each logical address in a first set of logical addresses in the access command may correspond to a respective group-mapping table 401 (i.e., the first scenario), and the logical addresses in a second set of logical addresses in the access command may correspond to another group-mapping table 401 (i.e., the second scenario). That is, the operations performed on the access-information table 410 may include the first scenario and/or the second scenario.

Specifically, since the access command (e.g., a write command) from the host 120 has written data to the flash memory 180, the mapping relationships in one or more group-mapping tables 401 stored in the DRAM 190 corresponding to one or more logical addresses in the access command are updated by the memory controller 160. Accordingly, the memory controller 160 may write the updated one or more group-mapping tables 401 into the flash memory 180 in an appropriate time (e.g., a predetermined condition is satisfied). Afterwards, the memory controller 160 may determine whether the predetermined condition is satisfied to write the updated group-mapping table(s) 401 into the flash memory 180. For example, in response to the predetermined condition being satisfied, the memory controller 160 may write the updated group-mapping table(s) 401 into the flash memory 180.

In some embodiments, the memory controller 160 may write an individual updated group-mapping table 401 (e.g., 4K bytes) into the flash memory 180. In this situation, the memory controller 160 may directly determine that the predetermined condition is satisfied, and write the updated group-mapping table 401 into the flash memory 180.

In some embodiments, in order to improve the performance of the data storage device 104, the memory controller 160 may write data into the flash memory 180 using superpages, and the memory controller 160 may accumulate data of several pages and then write the accumulated data of several pages using a superpage. For example, if a one-way-four-channel architecture is used in the flash memory 180, such as i=0 and j=3 in the architecture of the flash memory 180 shown in FIG. 2, one superpage may include 4 pages. That is, a superpage may store data of 4 pages. If a four-way-two-channel architecture is used in the flash memory 180, such as i=3 and j=1 in the architecture of the flash memory 180 shown in FIG. 2, one superpage may include 8 pages. That is, a superpage may store data of 8 pages, and so forth.

In the embodiment, the predetermined condition may indicate that the memory controller 160 has to accumulate a predetermined number of updated group-mapping tables 401. Accordingly, when the memory controller 160 has accumulated the predetermined number of updated group-mapping tables 401, the memory controller 160 may write the predetermined number of updated group-mapping tables 401 into one superpage. If the predetermined number of updated group-mapping tables 401 cannot be accumulated in the procedure of the current access command, the memory controller 160 may reserve the updated group-mapping tables 401 corresponding to the current access command in the DRAM 190, and then receive the next access command from the host 120. In addition, the flag 412 in the column 411 of the access-information table corresponding to each of the updated group-mapping tables 401 is still kept at 1. Accordingly, the aforementioned updated group-mapping tables 401 is still excluded from the predetermined replacement mechanism performed by the memory controller 160 at this time.

It should be noted that the storage space of the DRAM 190 cannot contain all of the group-mapping tables 401 in the L2P table 400, and only a predetermined number of group-mapping tables 401 can be stored in the DRAM 190. When the host 120 repeatedly performs data accessing operations to the flash memory 180 via the memory controller 160, the memory controller 160 may repeatedly perform the replacement operations on each group-mapping table 401 stored in the DRAM 190. That is, the memory controller 160 may, according to the predetermined replacement mechanism, replace one or more group-mapping tables 401 originally stored in the DRAM 190 with the one or more group-mapping tables 401 newly read from the flash memory 180.

However, before the memory controller 160 writes the updated one or more group-mapping tables 401 into the flash memory 180, the memory controller 160 will not replace the updated one or more group-mapping tables 401 in the DRAM with other group-mapping tables 401 newly read from the flash memory 180. That is, in response to the flag 412 or access count 413 in the access-information table corresponding to a specific group-mapping table 401 stored in the DRAM 190 not being zero, the specific group-mapping table 401 will not be added to the candidate list of group-mapping tables of the predetermined replacement mechanism by the memory controller 160.

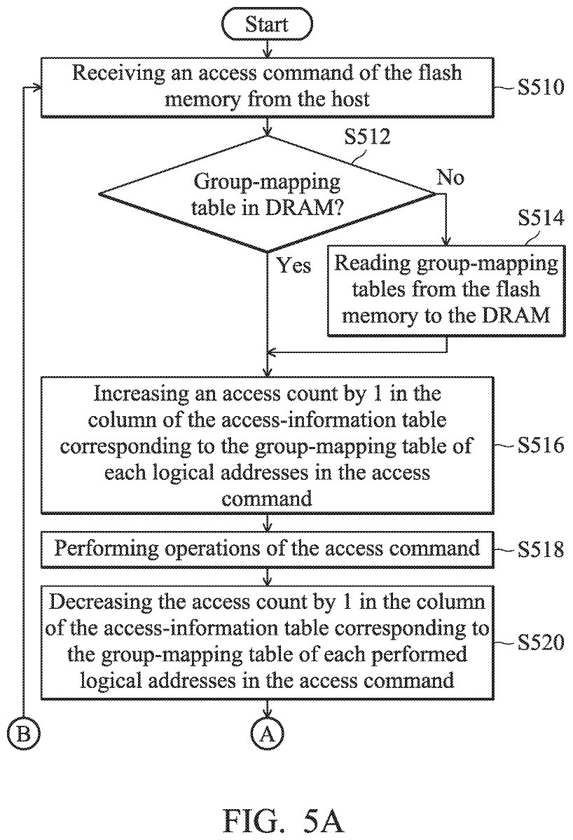

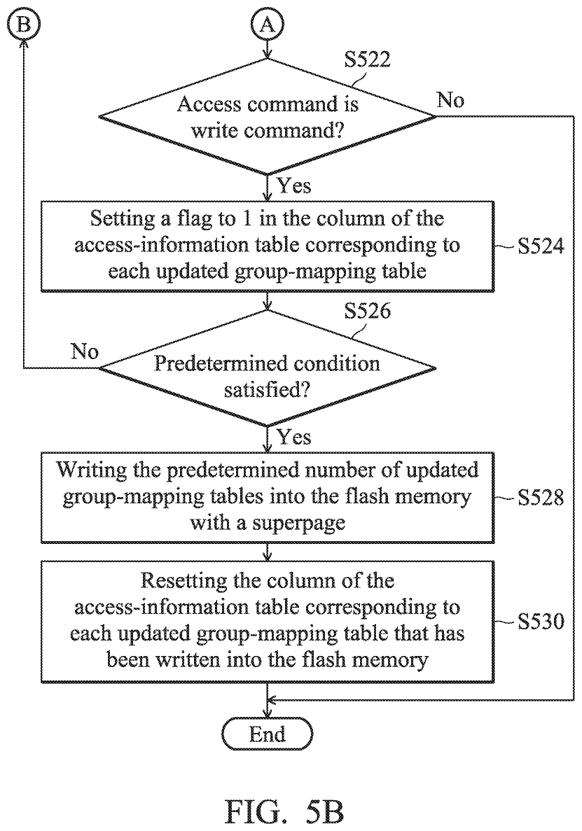

FIGS. 5A and 5B are sets of a flow chart of a method for accessing a logical-to-physical mapping table in accordance with an embodiment of the invention.

Referring to FIG. 1 and FIGS. 5A-5B, in step S510, the memory controller 160 receives an access command of the flash memory 180 from the host 120, wherein the access command includes one or more logical addresses. For example, the logical addresses in the access command may be logical block addresses (LBAs), global host pages (GHPs), host blocks, host pages, etc. In addition, in order to optimize the usage of the flash memory 180, the storage space of the flash memory 180 is dynamically arranged to correspond to the logical addresses recognized by the host 120.

In step S512, it is determined whether a group-mapping table corresponding to each logical address in the access command has been stored in the DRAM 190. If the group-mapping table corresponding to each logical address in the access command has been stored in the DRAM 190, step S516 is performed. If the group-mapping table corresponding to each logical address in the access command has been stored in the DRAM 190, step S514 is performed.

In step S514, the group-mapping table corresponding to each logical address in the access command is read from the flash memory 180 to the DRAM 190.

In step S516, an access count CNT (i.e., access count 413) is increased by 1 in the column 411 of the access-information table corresponding to the group-mapping table 401 of each logical address in the access command. For example, as described in the aforementioned embodiments, the correspondences between the one or more logical addresses in the access command and the group-mapping tables 401 may include the first scenario and/or the second scenario. However, no matter whether the logical addresses and group-mapping tables 401 have one-to-one or many-to-one correspondences, the memory controller 160 may sequentially process each logical address in the access command. That is, the access count CNT is increased by 1 in the column 411 of the access-information table 410 corresponding to the group-mapping table 401 of each logical address. If the logical addresses and the group-mapping tables 401 have one-to-one correspondences, the access count is increased by 1 in the column 411 of the access-information table 410 corresponding to each group-mapping table 401. If the logical addresses and the group-mapping tables 401 have many-to-one correspondences (e.g., N logical addresses correspond to a specific group-mapping table 401), the access count is increased by N in the column 411 of the access-information table 410 corresponding to the specific group-mapping table 401.

In step S518, operations of the access command is performed. For example, the memory controller 160 may perform access operations to the flash memory 180 according to the access command. For example, when the access command is a write command, the memory controller 160 may write data to the flash memory 180. When the access command is a read command, the memory controller 160 may read data from the flash memory 180.

In step S520, the access count CNT is decreased by 1 in the column 411 of the access-information table corresponding to the group-mapping table 401 of each performed logical address in the access command. In some embodiments, steps S518 and S520 can be integrated into one step. For example, since the access command includes one or more logical addresses, if data is accessed using superpages during operations of the access command, the memory controller 160 may access different storage sub-units in the flash memory 180 according to each logical address in the access command, and the access count is decreased by 1 in the column 411 of the access-information table 410 corresponding to the group-mapping table 401 of each performed logical address in the access command.

In step S522, it is determined whether the access command is a write command. If the access command is a write command, step S524 is performed. If the access command is not a write command, the flow ends. For example, when the memory controller 160 is performing the write command, in addition to writing data into the flash memory 180, the memory controller 160 may also update one or more group-mapping tables 401 in the DRAM 190, thereby updating the physical-to-logical mapping relationships of the data written into the flash memory 180. It should be noted that the updated group-mapping tables 401 are not written into the flash memory 180 yet while performing step S522.

In step S524, a flag is set to 1 in the column 411 of the access-information table 410 corresponding to each updated group-mapping table 401. For example, the flag 412 in the column 411 of the access-information table 410 corresponding to each group-mapping table 401 can be regarded as a modification bit. In response to the flag 412 being 1, it indicates that the corresponding group-mapping table 401 has been modified (e.g., by the write command). In response to the flag 412 being 0, it indicates that the corresponding group-mapping table 401 has not been modified (e.g., by the read command).

In another embodiment, step S522 and step S524 can be integrated into step S516, and it is determined whether the access command is a write command in an earlier step of the flow. If it is determined that the access command is a write command, the flag 412 is directly set to 1 in the column 411 of the access-information table 410 corresponding to the group-mapping table of each logical address in the access command, and the access count CNT (i.e., access count 413) is increased by 1 in the column 411 of the access-information table 410 corresponding to the group-mapping table of each logical address in the access command.

In step S526, it is determined whether a predetermined condition is satisfied. If the predetermined condition is satisfied, step S528 is performed. If the predetermined condition is not satisfied, step S510 is performed. For example, in order to improve the performance of the data storage device 140, the memory controller 160 may write data into the flash memory 180 using superpages, and the memory controller 160 may accumulate data of several pages and then write the accumulated data of several pages using a superpage.

Accordingly, in step S528, the memory controller 160 writes the predetermined number of updated group-mapping tables 401 into the flash memory 180 with a superpage. If the predetermined number of updated group-mapping tables 401 cannot be accumulated in the procedure of the current access command, the memory controller 160 may reserve the updated group-mapping tables 401 corresponding to the current access command in the DRAM 190, and then receive the next access command from the host 120. In addition, the flag 412 in the column 411 of the access-information table corresponding to each of the updated group-mapping tables 401 is still kept at 1. Accordingly, the aforementioned updated group-mapping tables 401 is still excluded from the predetermined replacement mechanism performed by the memory controller 160 at this time.

In step S530, the column 411 of the access-information table 410 corresponding to each updated group-mapping table 401 that has been written into the flash memory 180 is reset. For example, after the memory controller 160 has written the updated group-mapping tables 401 into a superpage (i.e., physical superpage) of the flash memory 180, the memory controller 160 may reset the column 411 of the access-information table 410 corresponding to each updated group-mapping table 401 that has been written into the flash memory 180, such as resetting the flag 412 and access count 413 to 0. That is, the aforementioned group-mapping tables 401 in the DRAM 190 can be placed into the candidate list of group-mapping tables to be selected by the predetermined replacement mechanism.

In view of the above, a data storage device and a method for accessing the logical-to-physical mapping table are provided. The data storage device and the method are capable of providing a management mechanism in a condition that the capacity of the DRAM in the data storage device is not sufficient to store the entire logical-to-physical mapping table, such that the controller may temporarily lock the updated group-mapping tables in the DRAM to prevent the updated group-mapping tables from being replaced out of the DRAM before usage or being written back into the flash memory. In addition, the memory controller may accumulate a predetermined number of updated group-mapping tables and write the updated group-mapping tables into the flash memory with a superpage. Accordingly, the memory controller can avoid repeated reading of the group-mapping tables in the flash memory, and can improve the performance of the data storage device for updating the logical-to-physical mapping table.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory, comprising a plurality of blocks for storing data and a logical-to-physical (L2P) table, wherein the L2P table is divided into a plurality of group-mapping tables;
a dynamic random access memory (DRAM), configured to store a first set of the group-mapping tables; and
a memory controller, configured to receive an access command from a host, wherein the access command comprises one or more logical addresses;
wherein the memory controller is further configured to read a second set of the group mapping tables corresponding to the one or more logical addresses in the access command from the flash memory to replace at least one group-mapping table in the first set of the group-mapping tables according to a predetermined replacement mechanism,
wherein each group-mapping table in the second set of the group-mapping tables has a corresponding column in an access-information table, and the corresponding column comprises a flag and an access count,
wherein in response to the flag or the access count not being zero in the corresponding column of the access-information table corresponding to a specific group-mapping table in the second set of group-mapping tables, the memory controller excludes the specific group-mapping table from the predetermined replacement mechanism.

2. The data storage device as claimed in claim 1, wherein in response to the memory controller reading the second set of group-mapping tables from the flash memory to the DRAM according to the predetermined replacement mechanism, the memory controller sequentially increase the access count in the corresponding column of the access-information table corresponding to each group-mapping table in the second set of group-mapping tables.

3. The data storage device as claimed in claim 2, wherein in response to the access command being completed by the memory controller, the memory controller is further configured to sequentially decrease the access count in the corresponding column of the access-information table corresponding to each group mapping table in the second set of the group mapping tables.

4. The data storage device as claimed in claim 3, wherein:
the memory controller further determines whether the access command is a write command,
in response to the access command being a write command, the memory controller updates mapping relationships in each group-mapping table corresponding to each logical address in the access command, and sets the flag to 1 in the corresponding column of the access-information table corresponding to the group-mapping table of each logical address in the access command.

5. The data storage device as claimed in claim 4, wherein:
after the memory controller sets the flag to 1 in the corresponding column of the access-information table corresponding to the group-mapping table of each logical address in the access command, the memory controller further determines whether a predetermined condition is satisfied,
wherein the predetermined condition indicates that the updated group-mapping tables in the second set of group-mapping tables have reached a predetermined number.

6. The data storage device as claimed in claim 5, wherein:
in response to the memory controller determining that the predetermined condition is satisfied, the memory controller forms a superpage using the predetermined number of updated group-mapping tables in the second set of group-mapping tables, and writes the superpage into the flash memory.

7. The data storage device as claimed in claim 5, wherein the memory controller is further configured to reset the corresponding column of the access-information table corresponding to each updated group-mapping table that has been written into the flash memory.

8. The data storage device as claimed in claim 5, wherein:
in response to the memory controller determining that the predetermined condition is not satisfied, the controller receives another access command from the host.

9. The data storage device as claimed in claim 7, wherein:
in response to the memory controller resetting the corresponding column of the access-information table corresponding to each updated group-mapping table that has been written into the flash memory, the memory controller further places each updated group-mapping table that has been written into the flash memory in a candidate list of group-mapping tables of the predetermined replacement mechanism.

10. A method for accessing a logical-to-physical mapping (L2P) table in a data storage device, wherein the data storage device comprises a flash memory and a dynamic random access memory (DRAM), wherein the flash memory comprises a plurality of blocks for storing data and the L2P table, wherein the L2P table is divided into a plurality of group-mapping tables, and the DRAM stores a first set of the group-mapping tables, the method comprising:
receiving an access command from a host, wherein the access command comprises one or more logical addresses;
reading a second set of the group-mapping tables corresponding to the one or more logical addresses in the access command from the flash memory to replace at least one group-mapping table in the first set of the group-mapping tables according to a predetermined replacement mechanism, wherein each group-mapping table in the second set of the group-mapping tables has a corresponding column in an access-information table, and the corresponding column comprises a flag and an access count; and
in response to the flag or the access count not being zero in the corresponding column of the access-information table corresponding to a specific group-mapping table in the second set of group-mapping tables, excluding the specific group-mapping table from the predetermined replacement mechanism.

11. The method as claimed in claim 10, further comprising:
in response to the memory controller reading the second set of group-mapping tables from the flash memory to the DRAM according to the predetermined replacement mechanism, sequentially increasing the access count in the corresponding column of the access-information table corresponding to each group-mapping table in the second set of group-mapping tables.

12. The method as claimed in claim 11, further comprising:
in response to operations of the access command being completed, sequentially decreasing the access count in the corresponding column of the access-information table corresponding to each group-mapping table in the second set of the group-mapping table.

13. The method as claimed in claim 12, further comprising:
determining whether the access command is a write command;
in response to the access command being a write command, updating mapping relationships in each group-mapping table corresponding to each logical address in the access command, and setting the flag to 1 in the corresponding column of the access-information table corresponding to the group-mapping table of each logical address in the access command.

14. The method as claimed in claim 13, further comprising:
after setting the flag to 1 in the corresponding column of the access-information table corresponding to the group-mapping table of each logical address in the access command, determining whether a predetermined condition is satisfied,
wherein the predetermined condition indicates that the updated group-mapping tables in the second set of group-mapping tables have reached a predetermined number.

15. The method as claimed in claim 14, further comprising:
in response to determining that the predetermined condition is satisfied, forming a superpage using the predetermined number of updated group-mapping tables in the second set of group-mapping tables, and writing the superpage into the flash memory.

16. The method as claimed in claim 14, further comprising:
resetting the corresponding column of the access-information table corresponding to each updated group-mapping table that has been written into the flash memory.

17. The method as claimed in claim 14, further comprising:
in response to the memory controller determining that the predetermined condition is not satisfied, receiving another access command from the host.

18. The method as claimed in claim 16, further comprising:
in response to the corresponding column of the access-information table corresponding to each updated group-mapping table that has been written into the flash memory being reset, placing each updated group-mapping table that has been written into the flash memory in a candidate list of group-mapping tables of the predetermined replacement mechanism.
